(19) United States
(12) Patent Application Publication
(10) Pub. No.: US 2016/0021355 A1
(43) Pub. Date: Jan. 21, 2016

(54) Preprocessor for Full Parallax Light Field Compression

(71) Applicant: Ostendo Technologies, Inc., Carlsbad, CA (US)

(72) Inventors: Zahir Y. Alpaslan, San Marcos, CA (US); Danillo B. Graziosi, Carlsbad, CA (US); Hussein S. El-Ghoroury, Carlsbad, CA (US)

(21) Appl. No.: 14/799,269

(22) Filed: Jul. 14, 2015

Related U.S. Application Data
(60) Provisional application No. 62/024,889, filed on Jul. 15, 2014.

(51) Int. Cl. H04N 13/00; H04N 19/597; H04N 13/02

(52) U.S. Cl. CPC H04N 13/0029; H04N 13/0022; H04N 13/0242; H04N 13/0275; H04N 19/597; H04N 2013/0081; H04N 2213/005

(57) ABSTRACT

Preprocessing of the light field input data for full parallax compressed light field 3D display systems is described. The described light field input data preprocessing can be utilized to format or extract information from input data, which can then be used by the light field compression system to further enhance the compression performance, reduce processing requirements, achieve real-time performance and reduce power consumption. This light field input data preprocessing performs a high-level 3D scene analysis and extracts data properties to be used by the light field compression system at different stages. As a result, rendering of redundant data is avoided while at the same rendering quality is improved.

### CROSS REFERENCE TO RELATED APPLICATIONS

This application claims the benefit pursuant to 35 U.S.C. 119(e) of U.S. Provisional Application No. 62/024,889, filed Jul. 15, 2014, which application is specifically incorporated herein, in its entirety, by reference.

### BACKGROUND

1. Field

This invention relates generally to light field and 3D image and video processing, more particularly to the preprocessing of data to be used as input for full parallax light field compression and full parallax light field display systems.

2. Background

The following references are cited for the purpose of more clearly describing the present invention, the disclosures of which are hereby incorporated by reference:
[1] P050Z, U.S. Patent Application No. U.S. 61/926,069, Graziosi et al., Methods For Full Parallax 3D Compressed Imaging Systems, Jan. 10, 2014.
[2] U.S. patent application Ser. No. 13/659,776, El-Ghoroury et al., Spatio-Temporal Light Field Cameras, Oct. 24, 2012.
[3] U.S. Pat. No. 8,155,456, Babacan et al., Method and Apparatus for Block-based Compression of Light Field Images, Apr. 10, 2012
[4] El-Ghoroury et al., “Quantum Photonic Imagers and Method of Fabrication Thereof”, U.S. Pat. No. 7,623,560, published Nov. 24, 2009.
[5] El-Ghoroury et al., “Quantum Photonic Imagers and Method of Fabrication Thereof”, U.S. Pat. No. 7,829,902, published Nov. 9, 2010.
[6] El-Ghoroury et al., “Quantum Photonic Imagers and Method of Fabrication Thereof”, U.S. Pat. No. 7,767,479, published Aug. 3, 2010.
[7] El-Ghoroury et al., “Quantum Photonic Imagers and Method of Fabrication Thereof”, U.S. Pat. No. 8,049,231, published Nov. 1, 2011.
[8] El-Ghoroury et al., “Quantum Photonic Imagers and Method of Fabrication Thereof”, U.S. Pat. No. 8,243,770, published Aug. 14, 2012.
[9] El-Ghoroury et al., “Quantum Photonic Imagers and Method of Fabrication Thereof”, U.S. Pat. No. 8,567,960, published Oct. 29, 2013.
[10] El-Ghoroury, H. S., Alpaslan, Z. Y., “Quantum Photonic Imager (QPI): A New Display Technology and Its Applications,” (Invited) Proceedings of The International Display Workshops Volume 21, Dec. 3, 2014.
[11] Alpaslan, Z. Y., El-Ghoroury, H. S., “Small form factor full parallax tiled light field display,” Proceedings of Electronic Imaging, IS&T/SPIE Vol. 9391, Feb. 9, 2015.

The environment around us contains objects that reflect an infinite number of light rays. When this environment is observed by a person, a subset of these light rays is captured through the eyes and processed by the brain to create the visual perception. A light field display tries to recreate a realistic perception of an observed environment by displaying a digitized array of light rays that are sampled from the data available in the environment being displayed. This digitized array of light rays correspond to the light field generated by the light field display.

Different light field displays have different light field producing capabilities. Therefore the light field data has to be formatted differently for each display. Also the large amount of data required for displaying light fields and large amount of correlation that exists in the light field data gives way to light field compression algorithms. Generally light field compression algorithms are display hardware dependent and they can benefit from hardware specific preprocessing of the light field data.

Prior art light field display systems use inefficient compression algorithms. These algorithms first capture or render the scene 3D data or light field input data. Then this data is compressed for transmission within the light field display system, then the compressed data is decompressed, and finally the decompressed data is displayed.

With the introduction of new emissive and compressive displays it is now possible to realize full parallax light field displays with wide viewing angle, low power consumption, high refresh rate, high resolution, large depth of field and real time compression/decompression capability. New full parallax light field compression methods have been introduced to take advantage of the inherent correlation in the full parallax light field data very efficiently. These methods can reduce the transmission bandwidth, reduce the power consumption, reduce the processing requirements and achieve real-time encoding and decoding performance.

In order to achieve compression, prior art methods aim to improve the compression performance by preprocessing the input data to adapt the input characteristics to the display compression capabilities. For example, Ref. [3] describes a method that utilizes a preprocessing stage to adapt the input light field to the subsequent block-based compression stage. Since a block-based method was adopted in the compression stage, it is expected that the blocking artifacts introduced by the compression will affect the angular content, compromising the vertical and horizontal parallax. In order to adapt the content to the compression step, the input image is first transformed from elemental images to sub-images (gathering all angular information into one unique image), and then the image is re-sampled so that its dimension is divisible by the block size used by the compression algorithm. The method improves compression performance; nevertheless it is only tailored to block-based compression approaches and does not exploit the redundancies between the different viewing angles.

In Ref. [1], compression is achieved by encoding and transmitting only a subset of the light field information to the display. A 3D compressive imaging system receives the input data and utilizes the depth information transmitted along with the texture to reconstruct the entire light field. The process of selecting the images to be transmitted depends on the content and location of elements of the scene, and is referred to as the visibility test. The reference imaging elements are selected according to the position of objects relative to the camera location surface, and each object is processed in order of their distance from that surface and closer objects are processed before more distant objects. The visibility test procedure uses a plane representation for the objects and organizes the 3D scene objects in an ordered list. Since the full Parallax compressed light field 3D imaging system renders and displays objects from an input 3D database that could contain high level information such as objects description, or low level information such as simple point clouds, a preprocessing of the input data needs to be performed to extract the information used by the visibility test.

It is therefore the objective of this invention to introduce data preprocessing methods to improve light field compression stages used in the full parallax compressed light field 3D imaging systems. Additional objectives and advantages of this invention will become apparent from the following detailed description of a preferred embodiment thereof that proceeds with reference to the accompanying drawings.

### BRIEF DESCRIPTION OF THE DRAWINGS

In the following description, like drawing reference numerals are used for the like elements, even in different drawings. The matters defined in the description, such as detailed construction and elements, are provided to assist in a comprehensive understanding of the exemplary embodiments. However, the present invention can be practiced without those specifically defined matters. Also, well-known functions or constructions are not described in detail since they would obscure the invention with unnecessary detail. In order to understand the invention and to see how it may be carried out in practice, a few embodiments of it will now be described, by way of non-limiting example only, with reference to accompanying drawings, in which:

FIG. 1 illustrates the relationship of the displayed light field to the scene.

FIG. 2 illustrates prior art compression methods for light field displays.

FIG. 3 illustrates the efficient light field compression method of the present invention.

FIG. 4A and FIG. 4B illustrate the relationship of preprocessing with various stages of the efficient full parallax light field display system operation.

FIG. 5 illustrates preprocessing data types and preprocessing methods that divide the data for an efficient full parallax light field display system.

FIG. 6 illustrates the light field input data preprocessing of this invention within the context of the compressed rendering element of the full parallax compressed light field 3D light field imaging system of Ref. [1].

FIG. 7 illustrates how the axis-aligned bounding box of a 3D object within the light field is obtained from the objects coordinates by the light field input data preprocessing methods of this invention.

FIG. 8 illustrates a top-view of the full parallax compressed light field 3D display system and the object being modulated showing the frusta of the imaging elements selected as reference.

FIG. 9 illustrates a light field containing two 3D objects and their respective axis-aligned bounding box.

FIG. 10 illustrates the imaging elements reference selection procedure used by the light field preprocessing of this invention in the case a light field containing multiple objects.

FIG. 11 illustrates one embodiment of this invention in which the 3D light field scene incorporates objects represented by a point cloud.

FIG. 12 illustrates various embodiments of this invention where light field data is captured by sensors.

FIG. 13 illustrates one embodiment of this invention where preprocessing is applied on data captured by a 2D camera array.

FIG. 14 illustrates one embodiment of this invention where preprocessing is applied on data captured by a 3D camera array.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

In the following description, reference is made to the accompanying drawings, which illustrate several embodiments of the present invention. It is understood that other embodiments may be utilized, and mechanical compositional, structural, electrical, and operational changes may be made without departing from the spirit and scope of the present disclosure. The following detailed description is not to be taken in a limiting sense, and the scope of the embodiments of the present invention is defined only by the claims of the issued patent.

The terminology used herein is for the purpose of describing particular embodiments only and is not intended to be limiting of the invention. Spatially relative terms, such as “beneath”, “below”, “lower”, “above”, “upper”, and the like may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (e.g., rotated 90 degrees or at other orientations) and the spatially relative descriptors used herein interpreted accordingly.

As used herein, the singular forms “a”, “an”, and “the” are intended to include the plural forms as well, unless the context indicates otherwise. It will be further understood that the terms “comprises” and/or “comprising” specify the presence of stated features, steps, operations, elements, and/or components, but do not preclude the presence or addition of one or more other features, steps, operations, elements, components, and/or groups thereof.

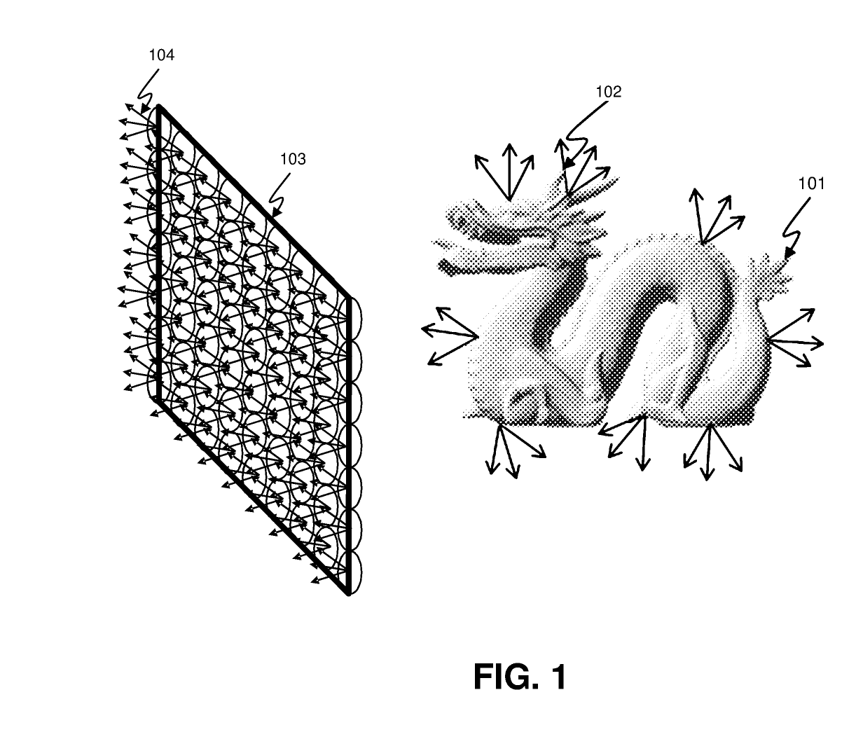

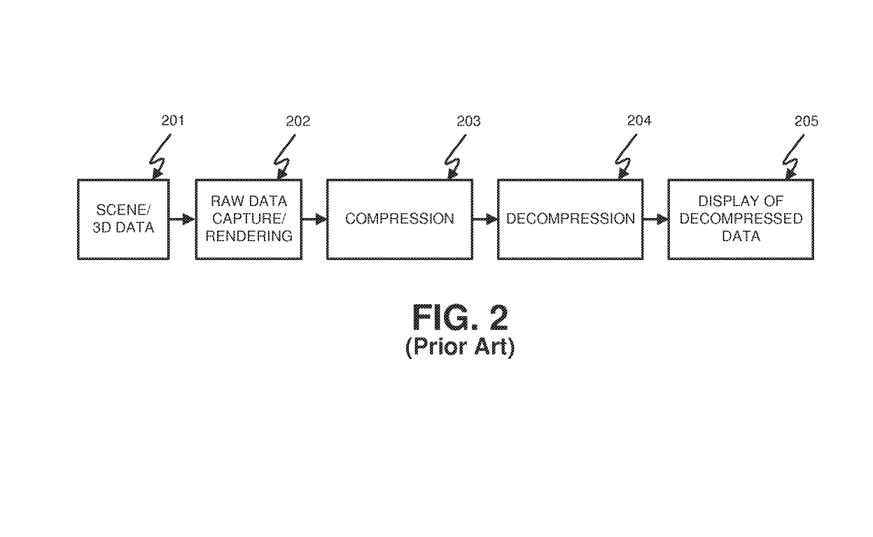

As shown in FIG. 1, an object 101 reflects an infinite number of light rays 102. A subset of these light rays is captured through the eyes of an observer and processed by the brain to create a visual perception of the object. A light field display 103 tries to recreate a realistic perception of an observed environment by displaying a digitized array of light rays 104 that are sampled from the data available in the environment. This digitized array of light rays 104 correspond to the light field generated by the display. Prior art light field display systems, as shown in FIG. 2, first capture or render 202 the scene 3D data or light field input data 201 that represents the object 101. This data is compressed 203 for transmission, decompressed 204, and then displayed 205.

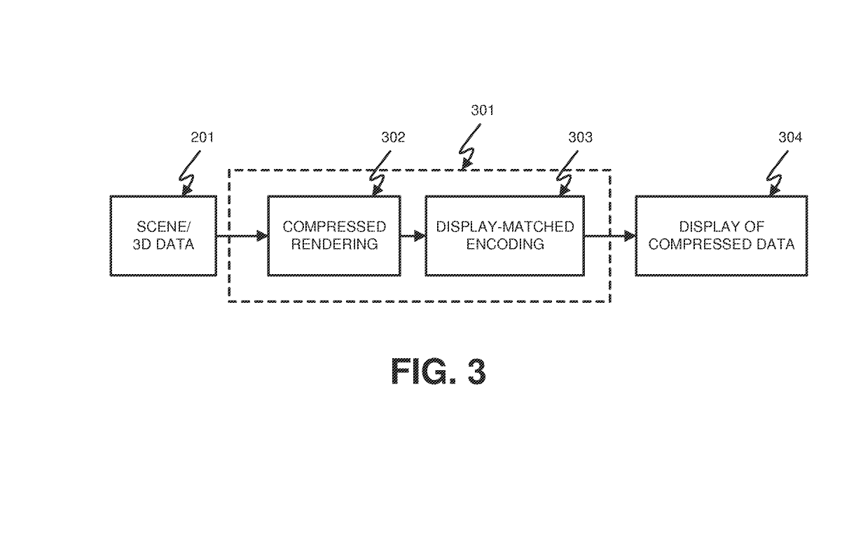

Recently introduced light field display systems, as shown in FIG. 3, use efficient full parallax light field compression methods to reduce the amount of data to be captured by determining which elemental images (or holographic elements “hogels”) are the most relevant to reconstruct the light field that represents the object 101. In these systems, scene 3D data 201 is captured via a compressed capture method 301. The compressed capture 301 usually involves a combination of compressed rendering 302 and display-matched encoding 303, to capture the data in a compressed way that can be formatted to the light field display's capabilities. Finally, the display can receive and display the compressed data. The efficient compression algorithms as described in Ref. [1] depend on preprocessing methods which supply a priori information that is required. This a priori information is usually in the form of, but not limited to, object locations in the scene, bounding boxes, camera sensor information, target display information and motion vector information.

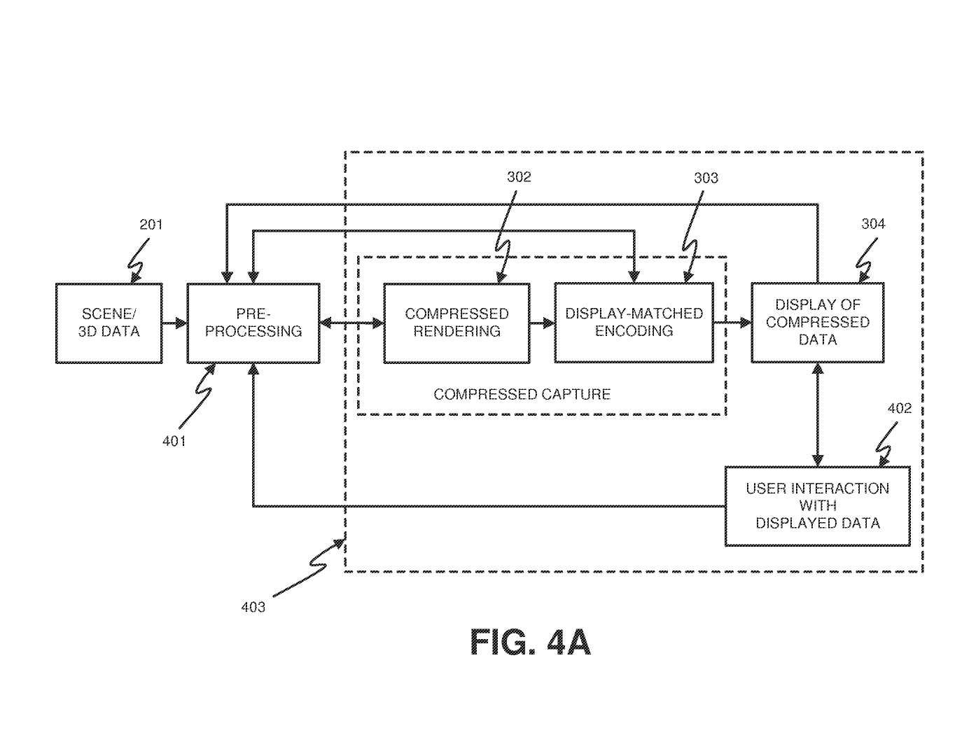

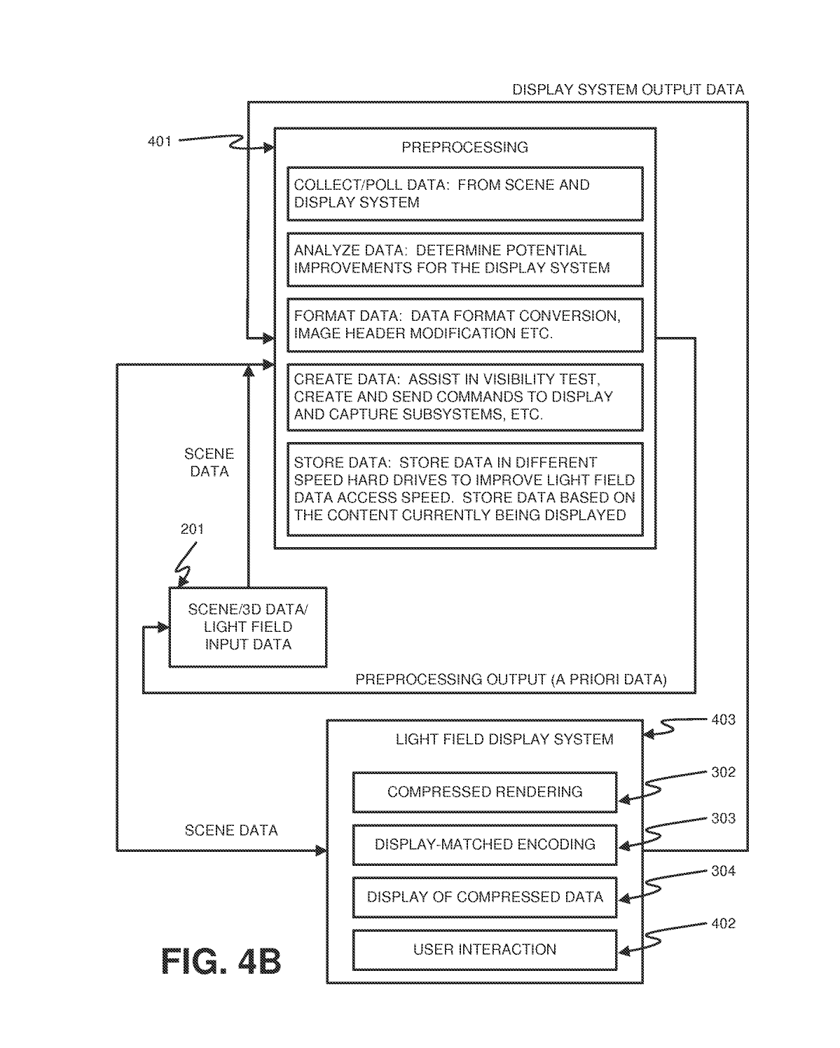

The preprocessing methods 401 for efficient full parallax compressed light field 3D display systems 403 described in present invention can collect, analyze, create, format, store and provide light field input data 201 to be used at specific stages of the compression operation, see FIG. 4A and FIG. 4B. These preprocessing methods can be used prior to display of the information including but not limited to in rendering 302, encoding 303 or decoding and display 304 stages of the compression operations of the full parallax compressed light field 3D display systems to further enhance the compression performance, reduce processing requirements, achieve real-time performance and reduce power consumption. These preprocessing methods also make use of the user interaction data 402 that is generated while a user is interacting with the light field generated by the display 304.

The preprocessing 401 may convert the light field input data 201 from data space to the display space of the light field display hardware. Conversion of the light field input data from data space to display space is needed for the display to be able to show the light field information in compliance with the light field display characteristics and the user (viewer) preferences. When the light field input data 201 is based on camera input, the light field capture space (or coordinates) and the camera space (coordinates) are typically not the same and the preprocessor needs to be able to convert the data from any camera's (capture) data space to the display space. This is particularly the case when multiple cameras are used to capture the light field and only a portion of the captured light field in included in the viewer preference space.

This data space to display space conversion is done by the preprocessor 401 by analyzing the characteristics of the light field display hardware and, in some embodiments, the user (viewer) preferences. Characteristics of the light field display hardware include, but are not limited to, image processing capabilities, refresh rate, number of hogels and anglets, color gamut, and brightness. Viewer preferences include, but are not limited to, object viewing preferences, interaction preferences, and display preferences.

The preprocessor 401 takes the display characteristics and the user preferences into account and converts the light field input data from data space to display space. For example, if the light field input data consists of mesh objects, then preprocessing analyzes the display characteristics such as number of hogels, number of anglets and FOV, then analyzes the user preferences such as object placement and viewing preferences then calculates bounding boxes, motion vectors, etc. and reports this information to compression and display system. Data space to display space conversion includes data format conversion and motion analysis in addition to coordinate transformation. Data space to display space conversion involves taking into account the position of the light modulation surface (display surface) and the object's position relative to the display surface in addition to what is learned from compressed rendering regarding the most efficient (compressed) representation of the light field as viewed by the user.

When the preprocessing methods 401 interact with the compressed rendering 302, the preprocessing 401 usually involves preparing and providing data to aid in the visibility test 601 stage of the compressed rendering.

When the preprocessing methods 401 interact with the display matched encoding 303, the display operation may bypass the compressed rendering stage 302, or provide data to aid in the processing of the information that comes from the compressed rendering stage. In the case when the compressed rendering stage 302 is bypassed, preprocessing 401 may provide all the information that is usually reserved for compressed rendering 302 to display matched encoding 303, in addition include further information about the display system, settings and type of encoding that needs to be performed at the display matched encoding 303. In the case when the compressed rendering stage 302 is not bypassed, the preprocessing can provide further information in the form of expected holes, and the best set of residual data to increase the image quality, further information about display, settings and encoding method to be used in display matched encoding 303.

When the preprocessing methods 401 interact with the display of compressed data 304 directly, the preprocessing can affect the operational modes of the display, including but not limited to: adjusting the field of view (FOV), number of anglets, number of hogels, active area, brightness, contrast, color, refresh rate, decoding method and image processing methods in the display. If there is already preprocessed data stored in the display's preferred input format, then this data can bypass compressed rendering 302 and display matched encoding 303, and be directly displayed 304, or either compressed rendering and/or display matched encoding stages can be bypassed depending on the format of the available light field input data and the operation currently being performed on the display by user interaction 402.

Interaction of the preprocessing 401 with any of the subsystems in the imaging system as shown in FIG. 4A and FIG. 4B are bidirectional and would require at least a handshake in communications. Feedback to the preprocessing 401 can come from Compressed Rendering 302, Display Matched Encoding 303, Light Field Display 304, and User Interaction 402. The preprocessing 401 adapts to the needs of the light field display system 304 and the user (viewer) preferences 402 with use of feedback. The preprocessing 401 determines what the display space is according to the feedback it receives from the light field display system 304. Preprocessing 401 uses this feedback in data space to display space conversion.

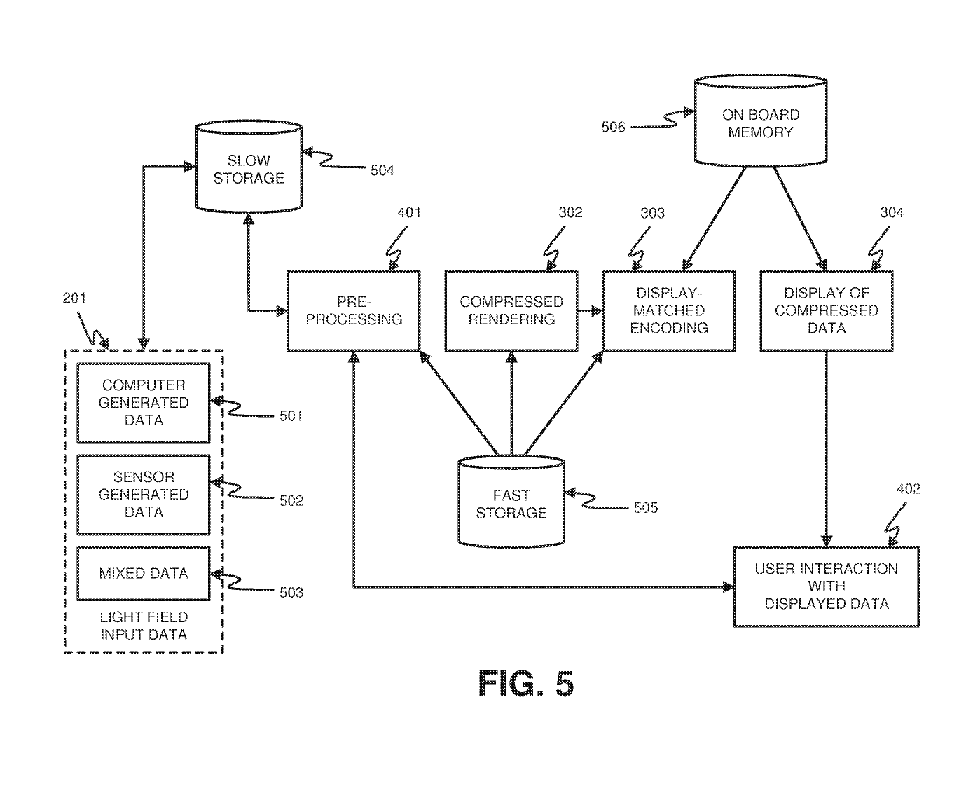

As stated earlier, the feedback is an integral part of the light field display and the user (viewer) preferences that are used by preprocessing of the light field input 401. As another example of feedback, the compressed rendering 302 may issue requests to have the preprocessing 401 transfer selected reference hogels to faster storage 505 (FIG. 5). In another example of feedback, the display matched encoding 303 may analyze the number of holes in the scene and issue requests to preprocessing 401 for further data for the elimination of holes. The preprocessing block 401 could interpret this as a request to segment the image into smaller blocks, in order to tackle the self-occlusion areas created by the object itself. The display matched encoding 303 may provide the current compression mode to preprocessing 401. Exemplary feedback from the light field display 304 to the preprocessing 401 may include display characteristics and current operational mode. Exemplary feedback from user interaction 402 to the preprocessing 401 may include motion vectors of the objects, zoom information, and display mode changes. Preprocessed data for the next frame changes based on the feedback obtained in the previous frame. For example the motion vector data is used in a prediction algorithm to determine which objects will appear in the next frame, and this information can be accessed preemptively from the light field input data 201 by the preprocessing 401 to reduce transfer time and increase processing speed.

Preprocessing methods of the light field input data can be used for full parallax light field display systems that utilize input images from three types of sources, see FIG. 5:
Computer generated data 501: This type of light field input data is usually generated by computers they include but are not limited to: specialized hardware graphic processing units (GPU) rendered images, computer simulations, results of data calculations made in computer simulation;
Sensor generated data 502: This type of light field input data is generally captured from the real world using sensors, including but not limited to: Images taken with cameras (single cameras, array of cameras, light field cameras, 3D cameras, range cameras, cell phone cameras, etc.), other sensors that measure the world and create data out of it such as Light Detection And Ranging (LIDAR), Radio Detection And Ranging (RADAR), and Synthetic Aperture Radar (SAR) systems, and more;
Mix of computer generated and sensor generated data 503: This type of light field input data is created by combining the two data types above. For example photoshopping an image to create a new image, doing calculations on the sensor data to create new results, using an interaction device to interact with the computer generated image, etc.

Preprocessing methods of the light field input data can be applied on static or dynamic light fields and would typically be performed on specifically designed specialized hardware. In one embodiment of this invention preprocessing 401 is applied to convert the light field data 201 from one format such as LIDAR to another format such as mesh data and store the result in a slow storage medium 504 such as a hard drive with a rotating disk. Then the preprocessing 401 moves a subset of this converted information in slow storage 504 to fast storage 505 such as a solid state hard drive. The information in 505 can be used by compressed rendering 302 and display matched encoding 303 and it usually would be a larger amount of data then what can be displayed on the light field display. The data that can be immediately displayed on a light field display is stored in the on board memory 506 of the light field display 304. Preprocessing can also interact with the on board memory 506 to receive information about the display and send commands to the display that may be related to display operational modes, and applications. Preprocessing 401 makes use of the user interaction data to prepare the display and interact with the data stored in different storage mediums. For example, if a user wants to zoom in, preprocessing would typically move a new set of data from the slow storage 504 to fast storage 505, and then send commands to the on board memory 506 to adjust the display refresh rate the data display method such as the method for decompression.

Other examples of system performance improvements due to preprocessing with different speed storage devices include: User interaction performance improvements and compression operation speed improvements. In one embodiment of the present invention, if a user is interacting with high altitude light field images of a continent in the form of point cloud data and is currently interested in examining the light field images of a specific city (or region of interest), this light field data about the city would be stored in the on board memory 506 of the display system. Predicting that the user may be interested in examining light field images of the neighboring cities, the preprocessing can load information about these neighboring cities into the fast storage system 505 by transferring this data from the slow storage system 504. In another embodiment of this invention the preprocessing can convert that data in the slow storage system 504 into a display system preferred data format, for example from point cloud data to mesh data, and save it back into the slow storage system 504, this conversion can be performed offline or in real-time. In another embodiment of this invention the preprocessing system can save different levels of detail for the same light field data to enable faster zooming. For example 1×, 2×, 4×, and 8× zoom data can be created and stored in the slow storage devices 504 and then moved to fast storage 505 and on board memory 506 to display. In these scenarios the data that is stored on the fast storage would be decided by examining the user interaction 402. In another embodiment of this invention, preprocessing would enable priority access to light field input data 201 for the objects closer to the display surface 103 to speed up the visibility test 601 because an object closer to the display surface may require more reference hogels and, therefore, is processed first in the visibility test.

### Preprocessing Methods for Computer Generated (CG) Light Field Data

In a computer generated (CG) capture environment, where computer generated 3D models are used to capture and compress a full parallax light field image, some information would be already known before the rendering process is started. This information includes location of the models, size of the models, bounding box of the models, capture camera information (CG cameras) motion vectors of the models and target display information. Such information is beneficial and can be used in Compressed Rendering operations of the full parallax compressed light field 3D display systems as described in patent application Ref. [1] as a priori information.

In one preprocessing method the a priori information could be polled from the computer graphics card, or could be captured through measurements or user interaction devices through wired or wireless means 401.

In another preprocessing method, the a priori information could be supplied as a part of a command, as a communication packet or instruction from another subsystem either working as a master or a slave in a hierarchical imaging system. It could be a part of an input image as instructions on how to process that image in the header information.

In another preprocessing method, within the 3D imaging system the preprocessing method could be performed as a batch process by a specialized graphic processing unit (GPU), or a specialized image processing device prior to the light field rendering or compression operations. In this type of preprocessing, the preprocessed input data would be saved in a file or memory to be used at a later stage.

In another preprocessing method, preprocessing can also be performed in real-time using a specialized hardware system having sufficient processing resources before each rendering or compression stage as new input information becomes available. For example, in an interactive full parallax light field display, as the interaction information 402 becomes available, it can be provided to the preprocessing stage 401 as motion vectors. In this type of preprocessing the preprocessed data can be used immediately in real-time or can be saved for a future use in memory or in a file.

The full parallax light field compression methods described in Ref [1] combine the rendering and compression stages into one stage called compressed rendering 302. Compressed rendering 302 achieves its efficiencies through the use of the priori known information about the light field. In general such priori information would include the objects location and bounding boxes in the 3D scene. In the compressed rendering method of the full parallax light field compression system described in Ref. [1] a visibility test makes use of such a priori information about the objects in the 3D scene to select the best set of imaging elements (or hogels) to be used as reference.

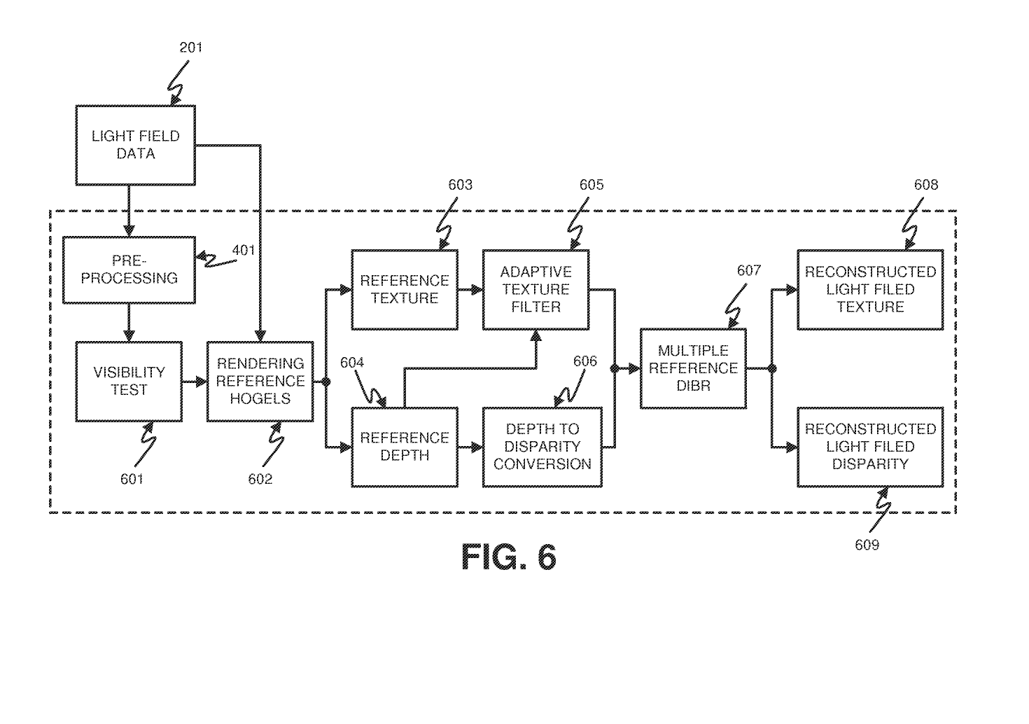

In order to perform the visibility test the light field input data must be formatted into a list of 3D planes representing objects, ordered by their distances to the light field modulation surface of the full parallax compressed light field 3D display system. FIG. 6 illustrates the light field input data preprocessing of this invention within the context of the compressed rendering element 302 of the full parallax compressed light field 3D imaging system of Ref. [1].

The preprocessing block 401 receives the light field input data 201, and extracts the information necessary for the visibility test 601 of Ref. [1]. The visibility test 601 will then select the list of imaging elements (or hogels) to be used as reference by utilizing the information extracted from the preprocessing block 401. The rendering block 602 will access the light field input data and render only the elemental images (or hogels) selected by the visibility test 601. The reference texture 603 and depth 604 are generated by the rendering block 602, and then the texture is further filtered by an adaptive texture filter 605 and the depth is converted to disparity 606. The multi-reference depth image based rendering (MR-DIBR) 607 utilizes the disparity and the filtered texture to reconstruct the entire light field texture 608 and disparity 609.

The light field input data 201 can have several different data formats, from high level object directives to low level point cloud data. However, the visibility test 601 only makes use of a high level representation of the light field input data 201. The input used by the visibility test 601 would typically be an ordered list of 3D objects within the light field display volume. In this embodiment such an ordered list of 3D objects would be in reference to the surface of the axis-aligned bounding box closest to the light field modulation (or display) surface. The ordered list of 3D objects is a list of 3D planes representing the 3D objects, ordered by their distances to the light field modulation surface of the full parallax compressed light field 3D display system. A 3D object may be on the same side of the light field modulation surface as the viewer or on the opposite side with the light field modulation surface between the viewer and the 3D object. The ordering of the list is by distance to the light field modulation surface without regard to which side of the light field modulation surface the 3D object is on. In some embodiments, the distance to the light field modulation surface may be represented by a signed number that indicates which side of the light field modulation surface the 3D object is on. In these embodiments the ordering of the list is by the absolute value of the signed distance value.

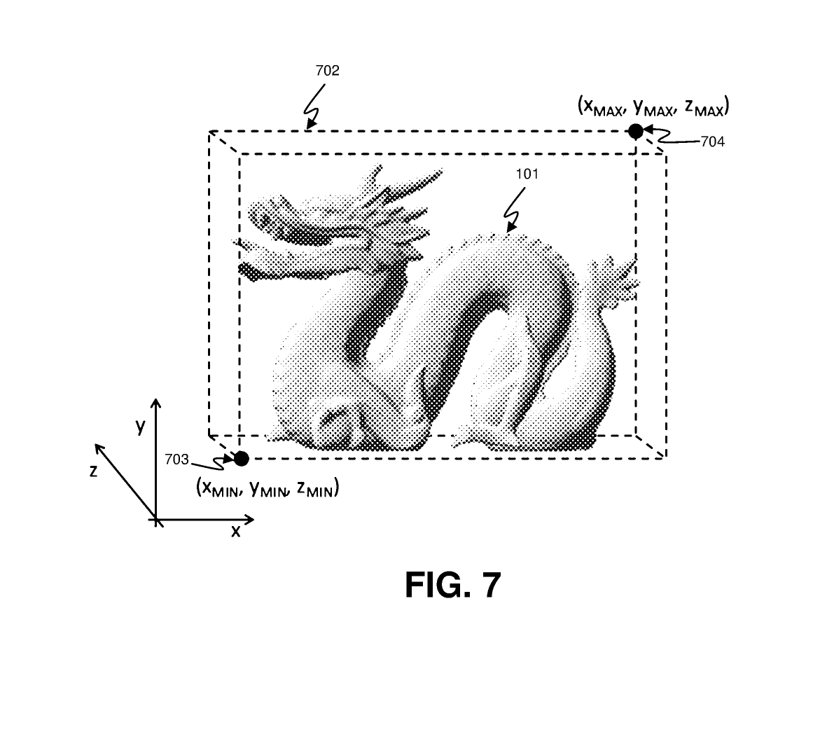

As illustrated in FIG. 7 the axis-aligned bounding box, which is aligned to the axes of the light field display 103, can be obtained by the analysis of the coordinates of the light field input data 201. In the source light field input data 201, the 3D scene object 101 would typically be represented by a collection of vertices. The maximum and minimum values of the coordinates of such vertices would be analyzed by the light field input data preprocessing block 401 in order to determine an axis-aligned bounding box 702 for the object 101. One corner 703 of the bounding box 702 has the minimum values for each of the three coordinates found amongst all of the vertices that represent the 3D scene object 101. The diagonally opposite corner 704 of the bounding box 702 has the maximum values for each of the three coordinates from all of the vertices that represent the 3D scene object 101.

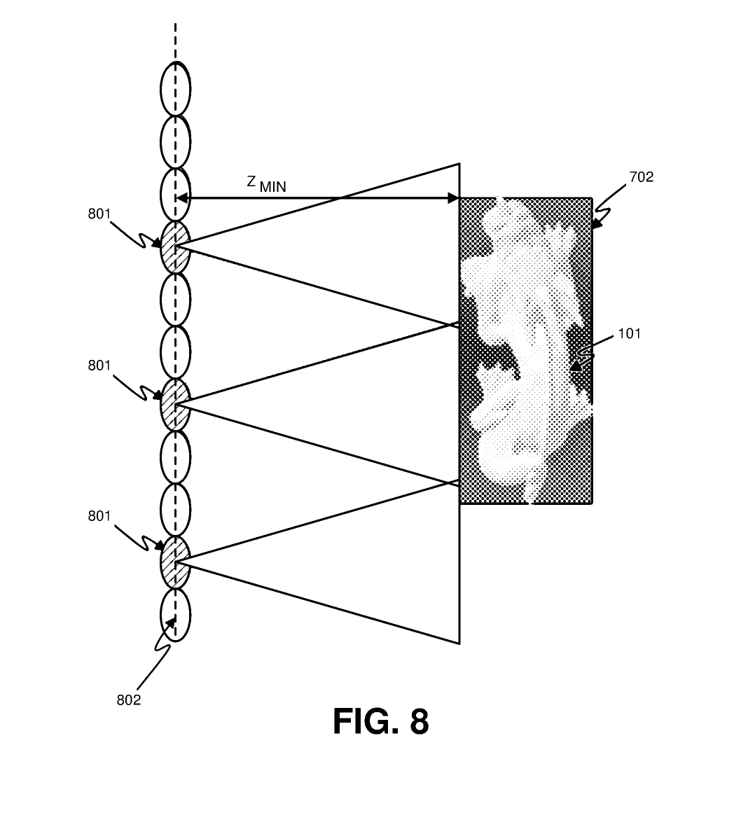

FIG. 8 illustrates a top-view of the full parallax compressed light field 3D display system and the object being modulated showing the frusta of the selected reference imaging elements 801. The imaging elements 801 are chosen so that their frusta cover the entire object 101 with minimal overlap. This condition selects reference hogels that are a few units apart from each other. The distance is normalized by hogels' size, so that an integer number of hogels can be skipped from one reference hogel to another. The distance between the references depends on the distance between the bounding box 702 and the capturing surface 802. The remaining hogels' textures are redundant and can be obtained from neighboring reference hogels and therefore are not selected as references. It should be noted that the surfaces of the bounding box are also aligned with the light field modulation surface of the display system. The visibility test 601 would use the surface of the bounding box closest to the light field modulation surface to represent the 3D object within the light field volume, since that surface will determine the minimum distance between the reference imaging elements 801. In another embodiment of this invention, surfaces of the first bounding box used by the light field preprocessing methods of this invention may not be aligned with modulation surface; in this embodiment a second bounding box aligned with the light field modulation surface of the display system is calculated as a bounding box for the first bounding box.

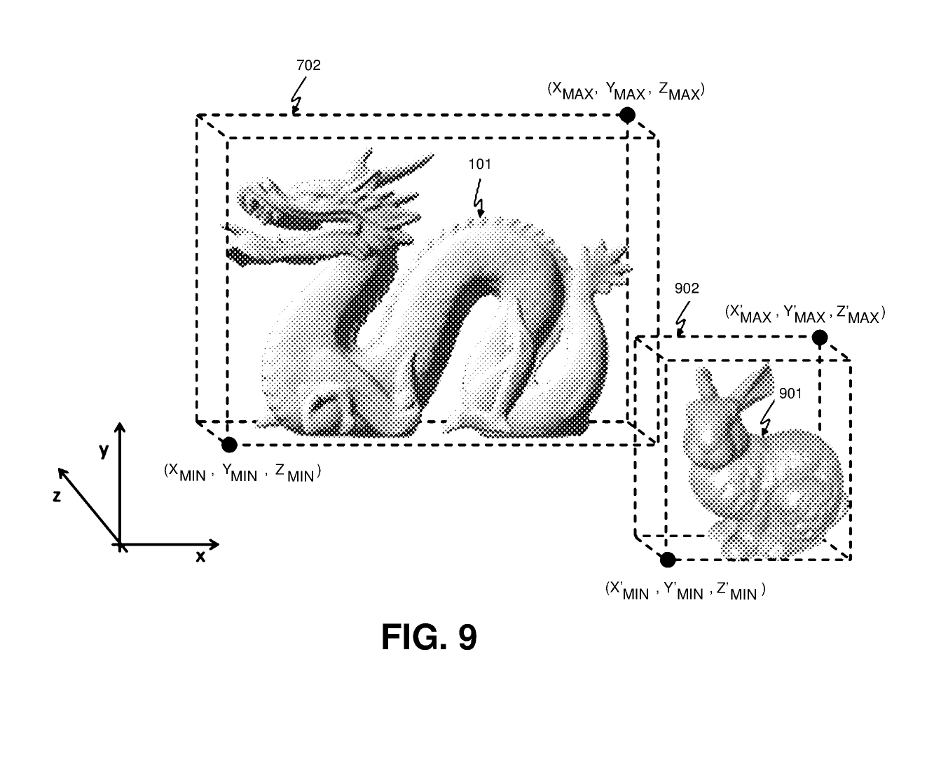

For the case of a 3D scene containing multiple objects such as the illustration of FIG. 9, a bounding box for each separate object would need to be determined. FIG. 9 illustrates a light field containing two objects, the Dragon object 101 and the Bunny object 901. The display system axis-aligned bounding box for the Bunny 902 illustrated in FIG. 9 would be obtained by the preprocessing block 401 in a similar way as described above for the Dragon 702.

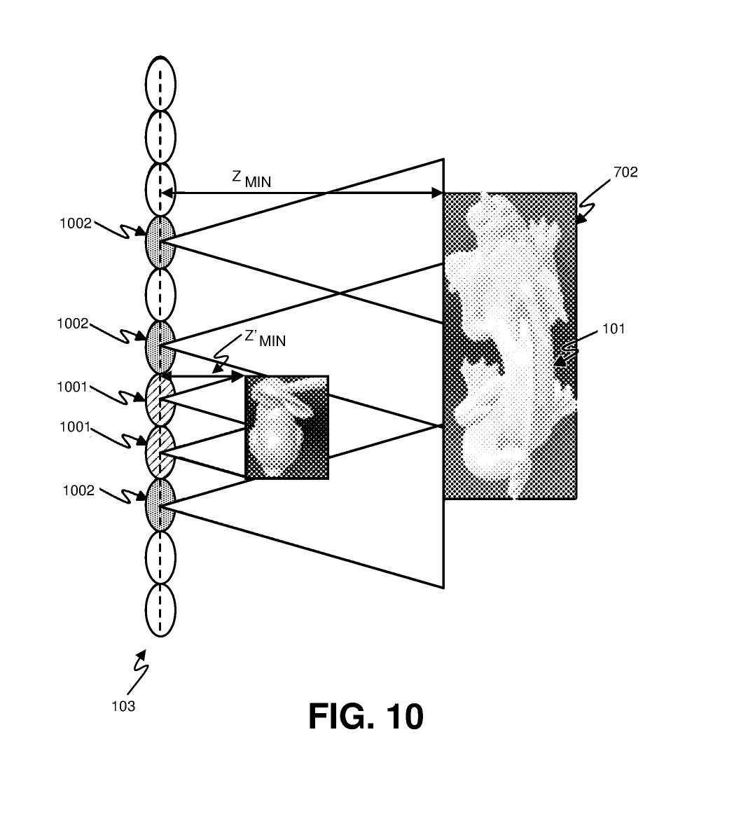

FIG. 10 illustrates the selection procedure for the reference imaging elements used by the light field preprocessing of this invention in the case of a scene containing multiple objects. In this embodiment the object closest to the display (in this case, the bunny object 901) would be analyzed first, and a set of reference imaging elements 1001 would be determined in a similar way as described above for the Dragon 702. Since the next object to be processed, the dragon object 101, is behind the bunny, extra imaging elements 1002 are added to the list of reference imaging elements, to account for the occlusion of the dragon object 101 by the bunny object 901. The extra imaging objects 1002 are added at critical areas, where texture from the dragon object 101, which is further away, is occluded by the bunny 901 for only certain views, but not for others. This area is identified as the boundary of the closer object, and reference hogels are placed so that their frusta covers the texture of the background up to the boundary of the object closer to the capturing surface. This means that extra hogels 1002 will be added to cover this transitory area, that contains background texture occluded by the closer object. When processing the light field input data 201 of objects further away from the light field modulation surface 103 in the 3D scene, in this case the dragon object 101, the reference imaging elements for the dragon object 101 may overlap the reference imaging elements already chosen for the objects closer to light field modulation surface 103, in this case the bunny object 901. When reference imaging elements for a more distant object overlap reference imaging elements already chosen for closer objects, no new reference imaging elements are added to the list. The processing of closer object prior to more distant objects makes the selection of references imaging elements denser at the beginning, thus increasing the chance of re-using reference imaging elements.

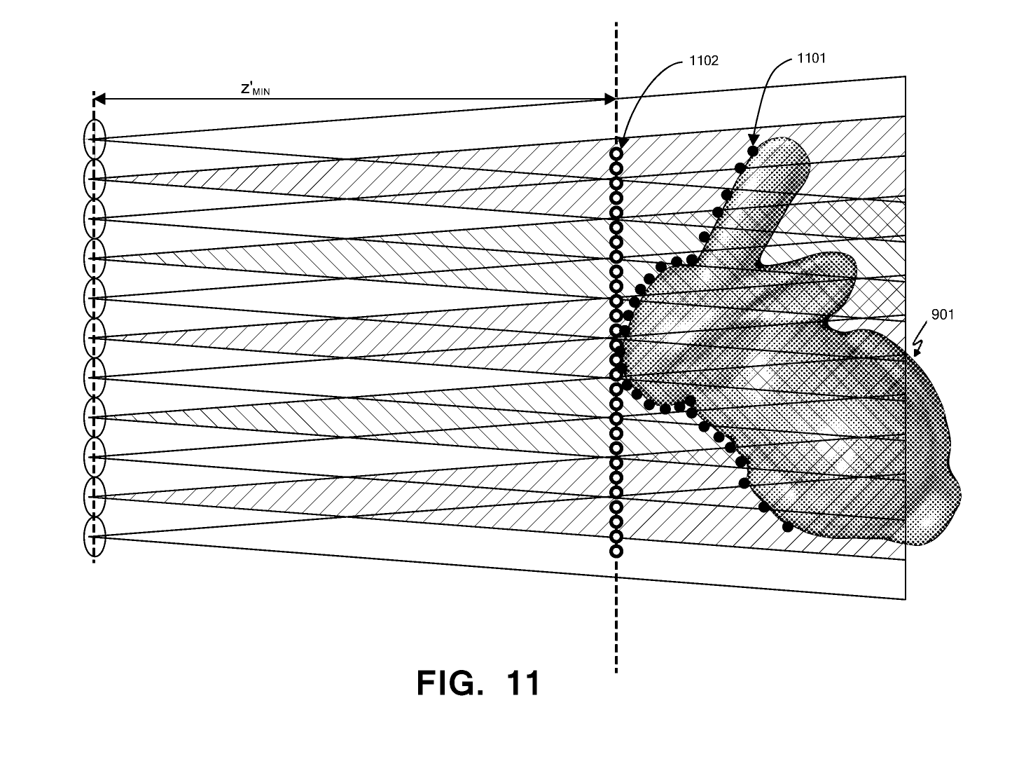

FIG. 11 illustrates another embodiment of this invention in which the 3D light field scene incorporate objects represented by a point cloud 1101 such as the bunny object 901. In order to identify the depth representing the bunny object 901 in the ordered list, the points of the bunny object 901 are sorted where the maximum and the minimum coordinates of all the points in bunny object 901 are identified for all axes to create a bounding box for the bunny object 901 in the ordered list of 3D objects within the point cloud data. Alternatively, a bounding box of the point cloud 1101 is identified and the closest surface 1102 of the bounding box that is parallel to the modulation surface 103 would be selected to represent the 3D object 901 in the ordered list of 3D objects within the point cloud data.

### Preprocessing Methods for Sensor Captured Content

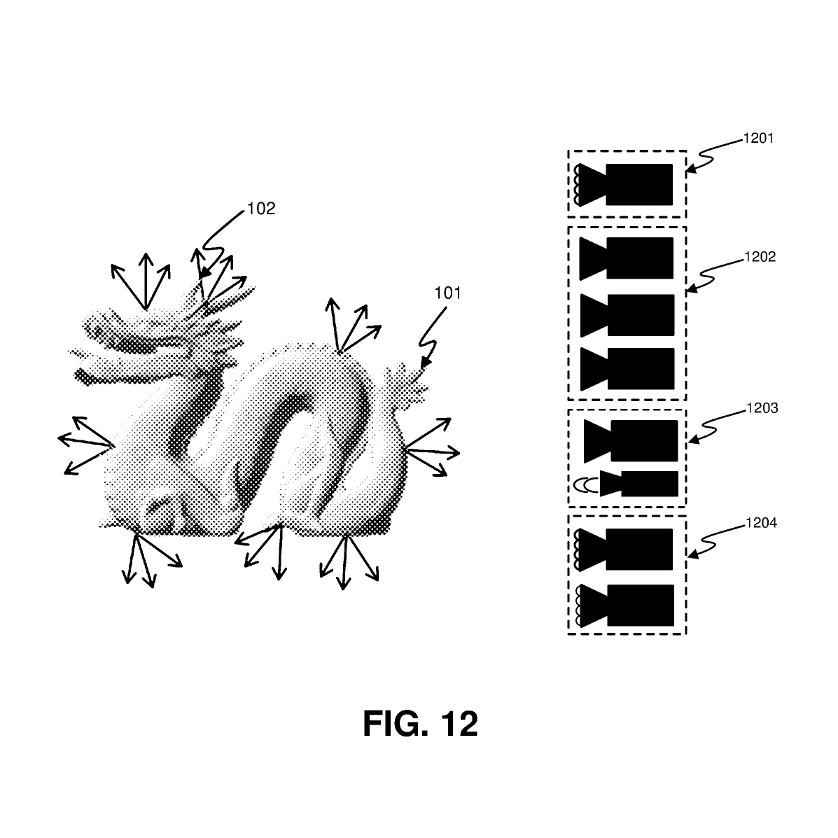

For displaying a dynamic light field 102, as in the case of displaying a live scene that is being captured by any of a light field camera 1201, by an array of 2D cameras 1202, by an array of 3D cameras 1203 (including laser ranging, IR depth capture, or structured light depth sensing), or by an array of light field cameras 1204, see FIG. 12, the light field input data preprocessing methods 401 of this invention and related light field input data would include, but are not limited to, accurate or approximate objects size, location and orientation of the objects in the scene and their bounding boxes, target display information for each target display, position and orientation of all cameras with respect to the 3D scene global coordinates.

In one preprocessing method 401 of this invention where a single light field camera 1201 is used to capture the light field, the preprocessed light field input data can include the maximum number of pixels to capture, specific instructions for certain pixel regions on the camera sensor, specific instructions for certain micro lens or lenslets groups in the camera lens and the pixels below the camera lens. The preprocessed light field input data can be calculated and stored before image capture, or it can be captured simultaneously or just before the image capture. In the case of when the preprocessing of the light field input data is performed right before the capture, a subsample of the camera pixels can be used to determine rough scene information, such as depth, position, disparity and hogel relevance for the visibility test algorithm.

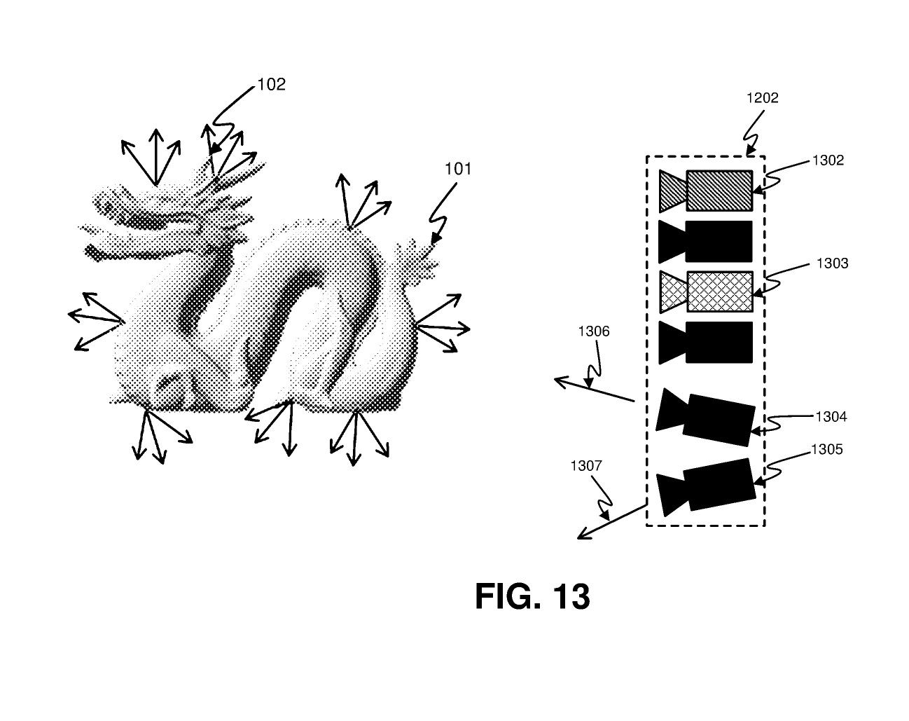

In another embodiment of this invention, see FIG. 13, multiple 2D cameras are used to capture a light field, the preprocessing 401 would include division of the cameras for a specific purpose, for example, each camera can capture a different color (a camera in location 1302 can capture a first color, camera in location 1303 can capture a second color, etc.) Also cameras in different locations can capture depth map information for different directions (camera in location 1304 and location 1305 can capture depth map information for a first direction 1306 and a second direction 1307, etc.), see FIG. 13. The cameras can use all their pixels or can only use a subset of their pixels to capture the required information. Certain cameras can be used to capture preprocessing information while other are used to capture the light field data. For example, while some cameras 1303 are determining which cameras should be used to capture the dragon object 101 scene by analyzing the scene depth the other cameras 1302, 1304, 1305 can capture the scene.

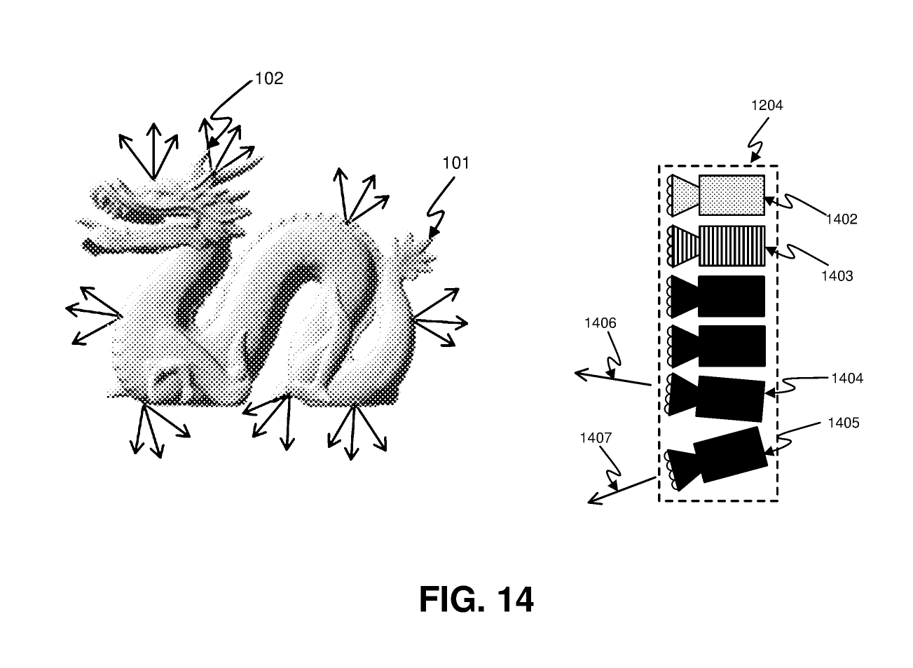

In another embodiment of this invention, see FIG. 14, a 3D camera array 1204 is used to capture a light field, the preprocessing 401 would include division of the cameras for a specific purpose. For example, a first camera 1402 can capture a first color, a second camera 1403 can capture a second color, etc. Also additional cameras 1404, 1405 can capture depth map information for the directions 1406, 1407 in which the cameras are aimed. In this embodiment the preprocessing 401 could make use of the light field input data from a subset of the cameras within the array using all their pixels or only using subset of their pixels to capture the required light field input information. With this method certain cameras within the array could be used to capture and provide light field data needed preprocessing at any instant of time while others are used to capture the light field input data at different instants of time dynamically as the light field scene changes. In this embodiment of preprocessing, the output of the preprocessing element 401 in FIG. 4, would be used to provide real-time feedback to the camera array to limit the number of pixels recorded by each camera, or reduce the number of cameras recording the light field as the scene changes.

In another embodiment of this invention the preprocessing methods of this invention are used within the context of the networked light field photography system of Ref. [2] to enable capture feedback to the cameras used to capture the light field. Ref. [2] describes a networked light field photography method that uses multiple light field and/or conventional cameras to capture a 3D scene simultaneously or over a period of time. The data from cameras in the networked light field photography system which captured the scene early in time can be used to generate preprocessed data for the later cameras. This preprocessed light field data can reduce the number for cameras capturing the scene or reduce the pixels captured by each camera, thus reducing the required interface bandwidth from each camera. Similar to 2D and 3D array capture methods described earlier, networked light field cameras can also be partitioned to achieve different functions.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those of ordinary skill in the art. The description is thus to be regarded as illustrative instead of limiting.

What is claimed is:

1. A preprocessor for a light field display system that provides full parallax, compressed, three dimensional processing of light field input data, the preprocessor comprising:
a data receiver that receives light field input data in a data space;
a display configuration receiver that receives configuration information for the light field display system; and
a display space converter that converts the data space of the light field input data responsive to the configuration information for the light field display system.

2. The preprocessor of claim 1 wherein the configuration information for the light field display system includes position information for a light field modulation surface of the light field display system.

3. The preprocessor of claim 2 wherein the display space converter converts the data space of the light field input data responsive to a distance between an object in the light field input data and the light field modulation surface of the light field display system.

4. The preprocessor of claim 2 further comprising a list generator that creates an ordered list of 3D planes representing objects in the light field input data, ordered by their distances to the light field modulation surface of the light field display system.

5. A method of preprocessing light field input data for a light field display system that provides full parallax, compressed, three dimensional processing of light field input data, the method comprising:
receiving the light field input data in a data space;
receiving configuration information for the light field display system; and
converting the data space of the light field input data responsive to the configuration information for the light field display system.

6. The method of claim 5 wherein the configuration information for the light field display system includes position information for a light field modulation surface of the light field display system.

7. The method of claim 6 further comprising converting the data space of the light field input data responsive to a distance between an object in the light field input data and the light field modulation surface of the light field display system.

8. The method of claim 6 further comprising creating an ordered list of 3D planes representing objects in the light field input data, ordered by their distances to the light field modulation surface of the light field display system.

9. A preprocessor for a light field display system that provides full parallax, compressed, three dimensional processing of light field input data, the preprocessor comprising:
an interaction receiver that receives selections generated interactively by a user; and
a data receiver that accesses light field input data to be provided to the light field display system to respond to the selections generated interactively by the user.

10. The preprocessor of claim 9 wherein the selections generated interactively by the user include motion vector data, and the data receiver preemptively accesses the light field input data responsive to the motion vector data in anticipation of the light field input data that will be provided to the light field display system.

11. The preprocessor of claim 9 wherein the selections generated interactively by the user include zoom information, and the data receiver preemptively accesses the light field input data responsive to the zoom information in anticipation of the light field input data that will be provided to the light field display system.

12. The preprocessor of claim 9 wherein the selections generated interactively by the user includes a display mode change, and the data receiver accesses the light field input data to provide the light field input data to the light field display system responsive to the display mode change.

13. The preprocessor of claim 9 further comprising:
a first storage device that stores the light field input data, the first storage device having a first transfer speed; and
a second storage device having a second transfer speed that is faster than the first transfer speed;
wherein the preprocessor is coupled to the first storage device and the second storage device, the preprocessor receiving the light field input data from the first storage device and storing selected portions of the light field input data on the second storage device to respond to the selections generated interactively by the user.

14. A method of preprocessing light field input data for a light field display system that provides full parallax, compressed, three dimensional processing of light field input data, the method comprising:
receiving selections generated interactively by a user; and
accessing light field input data to be provided to the light field display system to respond to the selections generated interactively by the user.

15. The method of claim 14 wherein the selections generated interactively by the user include motion vector data, and accessing the light field input data further comprises preemptively accessing the light field input data responsive to the motion vector data in anticipation of the light field input data that will be provided to the light field display system.

16. The method of claim 14 wherein the selections generated interactively by the user include zoom information, and accessing the light field input data further comprises preemptively accessing the light field input data responsive to the zoom information in anticipation of the light field input data that will be provided to the light field display system.

17. The method of claim 14 wherein the selections generated interactively by the user include a display mode change, and accessing the light field input data further comprises accessing the light field input data to provide the light field input data to the light field display system responsive to the display mode change.

18. The method of claim 14 further comprising:
storing the light field input data on a first storage device having a first transfer speed; and
receiving the light field input data from the first storage device and storing selected portions of the light field input data on a second storage device to respond to the selections generated interactively by the user, the second storage device having a second transfer speed that is faster than the first transfer speed.

19. A preprocessor for a light field display system that provides full parallax, compressed, three dimensional processing of light field input data, the preprocessor comprising:
a data receiver that receives light field input data;
an object identifier that identifies a plurality of three dimensional objects in the light field input data to be displayed on a light field display;
a boundary identifier that generates a list of object boundary representations for the plurality of three dimensional objects.

20. The preprocessor of claim 19 wherein the boundary identifier:
finds minimum coordinate values and maximum coordinate values of vertices for each of the plurality of three dimensional objects to define a bounding box aligned with a light field modulation surface of the light field display;
selects a face of the bounding box that is parallel to and closest to the light field modulation surface of the light field display; and
includes the selected face in the list of object boundary representations.

21. The preprocessor of claim 20 wherein the boundary identifier first defines an unaligned bounding box and then defines the bounding box aligned with the light field modulation surface of the light field display for the unaligned bounding box for each of the plurality of three dimensional objects.

22. The preprocessor of claim 20 wherein the list of object boundary representations is ordered according to a distance of the selected face of the bounding box from the light field modulation surface of the light field display.

23. The preprocessor of claim 22 wherein the ordering according to the distance of the selected face of the bounding box from the light field modulation surface is without regard to whether the selected face of the bounding box is in front of or behind the light field modulation surface.

24. The preprocessor of claim 19 further comprising a display configuration receiver that receives position information for a light field modulation surface from the light field display.

25. The preprocessor of claim 19 further comprising:
a first storage device that stores the light field input data, the first storage device having a first transfer speed; and
a second storage device having a second transfer speed that is faster than the first transfer speed;
wherein the preprocessor is coupled to the first storage device and the second storage device, the preprocessor receiving the light field input data from the first storage device and storing selected portions of the light field input data on the second storage device.

26. A method of preprocessing light field input data for a light field display system that provides full parallax, compressed, three dimensional processing of light field input data, the method comprising:
identifying a plurality of three dimensional objects in light field input data to be displayed on a light field display;
generating a list of object boundary representations for the plurality of three dimensional objects.

27. The method of claim 26 further comprising:
finding minimum coordinate values and maximum coordinate values of vertices for each of the plurality of three dimensional objects to define a bounding box aligned with a light field modulation surface of the light field display;
selecting a face of the bounding box that is parallel to and closest to the light field modulation surface of the light field display; and
including the selected face in the list of object boundary representations.

28. The method of claim 27 further comprising first defining an unaligned bounding box and then defining the bounding box aligned with the light field modulation surface of the light field display for the unaligned bounding box for each of the plurality of three dimensional objects.

29. The method of claim 27 wherein the list of object boundary representations is ordered according to a distance of the selected face of the bounding box from the light field modulation surface of the light field display.

30. The method of claim 29 wherein the ordering according to the distance of the selected face of the bounding box from the light field modulation surface is without regard to whether the selected face of the bounding box is in front of or behind the light field modulation surface.

31. The method of claim 26 further comprising receiving position information for a light field modulation surface from the light field display.

32. The method of claim 30 further comprising:
storing the light field input data on a first storage device having a first transfer speed; and
receiving the light field input data from the first storage device and storing selected portions of the light field input data on a second storage device having a second transfer speed that is faster than the first transfer speed.

33. A preprocessor for a light field display system that provides full parallax, compressed, three dimensional processing of light field input data, the preprocessor comprising:
a data receiver that receives light field input data from a first storage device that stores the light field input data, the first storage device having a first transfer speed;
a light field data classifier that identifies portions of the light field input data to be processed by the light field display system; and
a data transmitter that stores the identified portions of the light field input data on a second storage device having a second transfer speed that is faster than the first transfer speed, the second storage device being coupled to the light field display system.

34. The preprocessor of claim 33 wherein the light field data classifier identifies portions of the light field input data that represent scenes adjacent to a scene being displayed as data to be processed by the light field display system.

35. The preprocessor of claim 33 wherein the light field data classifier identifies portions of the light field input data that represent a view of a portion of a scene being displayed as data to be processed by the light field display system.

36. The preprocessor of claim 33 wherein the data transmitter stores the identified portions of the light field input data on the second storage device such that the light field input data for objects that are closer to a light field modulation surface of a light field display can be transferred with priority access.

37. The preprocessor of claim 33 further comprising a list generator that creates an ordered list of 3D planes representing objects in the identified portions of the light field input data, ordered by their distances to a light field modulation surface of the light field display system.

38. A method of preprocessing light field input data for a light field display system that provides full parallax, compressed, three dimensional processing of light field input data, the method comprising:
receiving light field input data from a first storage device that stores the light field input data, the first storage device having a first transfer speed;
identifying portions of the light field input data to be processed by the light field display system; and
storing the identified portions of the light field input data on a second storage device having a second transfer speed that is faster than the first transfer speed, the second storage device being coupled to the light field display system.

39. The method of claim 38 wherein portions of the light field input data that represent scenes adjacent to a scene being displayed are identified as data to be processed by the light field display system.

40. The method of claim 38 wherein portions of the light field input data that represent a view of a portion of a scene being displayed are identified as data to be processed by the light field display system.

41. The method of claim 38 wherein the identified portions of the light field input data are stored on the second storage device such that light field input data for objects that are closer to a light field modulation surface of a light field display can be transferred with priority access.

42. The method of claim 38 further comprising creating an ordered list of 3D planes representing objects in the identified portions of the light field input data, ordered by their distances to a light field modulation surface of the light field display system.
